(19) United States
(12) Patent Application Publication
(10) Pub. No.: US 2023/0041424 A1
(43) Pub. Date: Feb. 9, 2023

(54) Fishing Rod Holder Device

(71) Applicant: Shawn Pettit, Medford, NJ (US)

(72) Inventor: Shawn Pettit, Medford, NJ (US)

(21) Appl. No.: 17/875,785

(22) Filed: Jul. 28, 2022

Related U.S. Application Data
(60) Provisional application No. 63/230,384, filed on Aug. 6, 2021.

(51) Int. Cl. B60R 9/08; B60R 9/058; A01K 97/10; B60R 9/048

(52) U.S. Cl. CPC B60R 9/08; B60R 9/058; A01K 97/10; B60R 9/048

(57) ABSTRACT

The present invention relates to a fishing rod holder device primarily comprised of a base, further comprised of at least one magnet and at least one base insert, at least one hinge, at least one lock, and a top member, further comprised of a top insert. Further, the device is comprised of a release button that easily disengages the locking mechanism and allows users to safely place their fishing rods into the device for easy use. The device provides a novel fishing rod holding device that allows a user to attach/detach the device to any vehicle without damaging the vehicle.

### CROSS-REFERENCE TO RELATED APPLICATION

The present application claims priority to, and the benefit of, U.S. Provisional Application No. 63/230,384, which was filed on Aug. 6, 2021, and is incorporated herein by reference in its entirety.

### FIELD OF THE INVENTION

The present invention relates generally to the field of fishing. More specifically, the present invention relates to a fishing rod holder device. The device is primarily comprised of a base, further comprised of at least one magnet and at least one base insert, at least one hinge, at least one lock, and a top member, further comprised of a top insert. Further, the device is comprised of a release button that easily disengages the locking mechanism and allows users to safely place their fishing rods into the device for easy use. The device provides a novel fishing rod holding device that allows a user to attach/detach the device to any vehicle roof via a magnet without damaging the vehicle. Accordingly, the present disclosure makes specific reference thereto. Nonetheless, it is to be appreciated that aspects of the present invention are also equally applicable to other like applications, devices, and methods of manufacture.

### BACKGROUND

By way of background, fishing is a very common hobby in which a large number of individuals partake in. Fishing rods can be expensive and can be much too long to place in the trunk of a vehicle. When individuals fish, they also often travel long distances to reach their fishing destination. During this travel, transporting fishing rods can be a hassle. Some vehicles may have permanent roof racks used to transport the fishing rods, but these devices have to be drilled into the roof of the vehicle. These permanent roof racks also cannot be moved from one vehicle to another, so users have to use the same vehicle in order to transport their fishing rods.

Therefore, there exists a long-felt need in the art for an improved portable roof rack that can safely transport fishing rods. There also exists a long-felt need in the art for a roof rack that can be attached to and detached from any vehicle without damaging the vehicle. There also exists a long-felt need in the art for a roof rack device that can store any size fishing rod and secure the rod safely for transport. Further, there exists a long-felt need in the art, for a magnetic roof rack that provides users with a simple and worry-free way to transport fishing rods.

The subject matter disclosed and claimed herein, in one embodiment thereof, comprises a fishing rod holder device. The device is primarily comprised of a base, further comprised of at least one magnet and at least one base insert, at least one hinge, at least one lock, and a top member, further comprised of a top insert. Further, the device is comprised of a release button that easily disengages the locking mechanism and allows users to safely place their fishing rods into the device for easy use. The device can magnetically attach to the roof of a vehicle, offering a non-permanent mounting and storing solution.

In this manner, the fishing rod holder device of the present invention accomplishes all of the foregoing objectives and provides a novel fishing rod holding device that allows a user to attach/detach the device to any vehicle without damaging the vehicle. Further, the device allows a user to place the device on any vehicle that an individual is using to commute to their destination and allows for any size fishing rod to be safely placed in the device without damaging the fishing rod.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a fishing rod holder device. The device is primarily comprised of a base, further comprised of at least one magnet and at least one hinge, at least one lock, and a top member. Further, the device is comprised of a release button that easily disengages the locking mechanism and allows users to safely place their fishing rods into the device for easy use.

Further, the device is comprised of at least one top insert and at least one bottom insert that allows for the fishing rods to be placed in between the top member and the base. These inserts fit to the shape of the fishing rod to keep the rod from being damaged or from moving while in the device. In one embodiment, the device is comprised of a pouch that allows a user to store other fishing supplies without the risk of losing them or having them become damaged.

Accordingly, the fishing rod holder device of the present invention is particularly advantageous as it provides a device that allows a user to carry any type of fishing rod on the vehicle of the user's choosing. The device allows the user to save time and energy by providing a removable roof rack that can be attached and detached from any vehicle without damaging the vehicle. In this manner, the fishing rod holder device provides a novel means of transporting fishing rods that does not damage the fishing rods or the vehicle. In this manner, the fishing rod holder device overcomes the limitations of existing methods of securing fishing rods known in the art.

Numerous benefits and advantages of this device will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a fishing rod holder device of the present invention in a closed position in accordance with the disclosed architecture;

FIG. 2 illustrates a perspective view of one potential embodiment of a fishing rod holder device of the present invention in an opened position in accordance with the disclosed architecture; and

FIG. 3 illustrates a perspective view of one potential embodiment of a fishing rod holder device of the present invention in a closed position while attached to a vehicle roof and while retaining fishing rods in accordance with the disclosed architecture; and

FIG. 4 illustrates a flowchart of one potential method of using one potential embodiment of the fishing rod holder device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved portable roof rack that can safely transport fishing rods. There also exists a long-felt need in the art for a roof rack that can be attached to and detached from any vehicle without damaging the vehicle. There also exists a long-felt need in the art for a roof rack device that can encompass any size fishing rod and secure the rod safely for transport. Further, the device provides users with a simple and worry-free way to transport their fishing rods.

The present invention, in one exemplary embodiment, is comprised of a fishing rod holder device. The device is primarily comprised of a base, further comprised of at least one magnet and at least one hinge, at least one lock, and a top member. Further, the device is comprised of a release button that easily disengages the locking mechanism and allows users to safely place their fishing rods into the device for easy use.

Further, the device is comprised of at least one top insert and at least one bottom insert that allows for the fishing rods to be placed in between the top member and the base. These inserts fit to the shape of the fishing rod to keep the pole from being damaged or from moving around while in the device. In one embodiment the device is comprised of a pouch that allows a user to store other fishing supplies without the risk of losing them or having them become damaged.

Accordingly, the fishing rod holder device of the present invention is particularly advantageous as it provides a device that allows a user to carry any type of fishing rod on the vehicle of the user's choosing. The device allows the user to save time and energy by providing a removable roof rack that can be attached and detached from any vehicle without damaging the vehicle. In this manner, the fishing rod holder device provides a novel means of transporting fishing rods that does not damage the fishing rods or the vehicle.

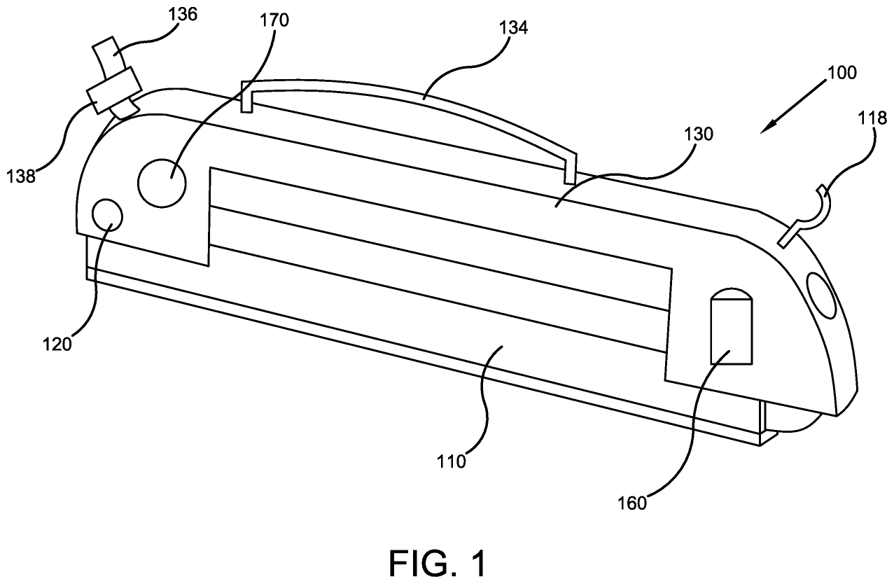

Referring initially to the drawings, FIG. 1 illustrates a perspective view of one potential embodiment of a fishing rod holder device 100 of the present invention in a closed position in accordance with the disclosed architecture. The device 100 is primarily comprised of a base 110, further comprised of at least one magnet 114 and at least one base insert 116, at least one hinge 120, at least one lock 140, and a top member 130, further comprised of a top insert 132. In varying embodiments, the device 100 can be made from any material such as, but not limited to, stainless steel, aluminum, plastic, wood, etc. In the preferred embodiment, the device 100 is made from a rigid/semi-rigid plastic such as, but not limited to: acrylic, polycarbonate, polyethylene, thermoplastic, acrylonitrile butadiene styrene, low-density polyethylene, medium density polyethylene, high-density polyethylene, polyethylene terephthalate, polyvinyl chloride, polystyrene, polylactic acid, acetal, nylon, fiberglass, etc.

Further, the device 100 can be any shape known in the art that allows for the attachment of the device 100 to the vehicle, as well as any shape that allows for the fishing rods 10 to be secured in the device without damaging the rods 10. In the preferred embodiment, two devices 100 may be used to secure a fishing rod 10.

The device 100 is further comprised of a base 110 that is comprised of at least one magnet 114 that allows the device to attach to the roof 12 or another area of the vehicle without damaging the vehicle surface. In the preferred embodiment, the base 110 may be made from the same material as the rest of the device 100. The device 100 is further comprised of at least one top member 130 that is preferably made from the same material as the base 110.

The device 100 also has at least one hinge 120 that allows for the device 100 to be opened and closed. The hinge 120 may be any hinge that is known in the art such as, but not limited to: an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc.

In one embodiment, the device 100 may have at least one handle 134 located on the top member 130. The handle 132 allows a user to transport and manipulate the device 100 with minimal effort. The handle 132 can also assist in detaching the device 100 from the vehicle by providing the user with an area to pull on to remove the device 100. The handle 132 can be any handle type/style known in the art. In another embodiment, the device 100 may have at least one strap 136 that can either be used to transport the device 100 or attach it to a roof rack that may already be fastened to a vehicle. The strap 136 is connected via at least one fastener 138 such as, but not limited to: hook and loop, snap button, buckle, etc. In yet another embodiment, the device 100 may be comprised of at least one hook 118 located on either the base 110 or the top member 130. The hook 118 provides the user with a convenient way to store the device 100 when it is not in use. The user can hang the device 100 on any wall or other surface via the hook 118. Further, the hook 118 may be any hook in the art.

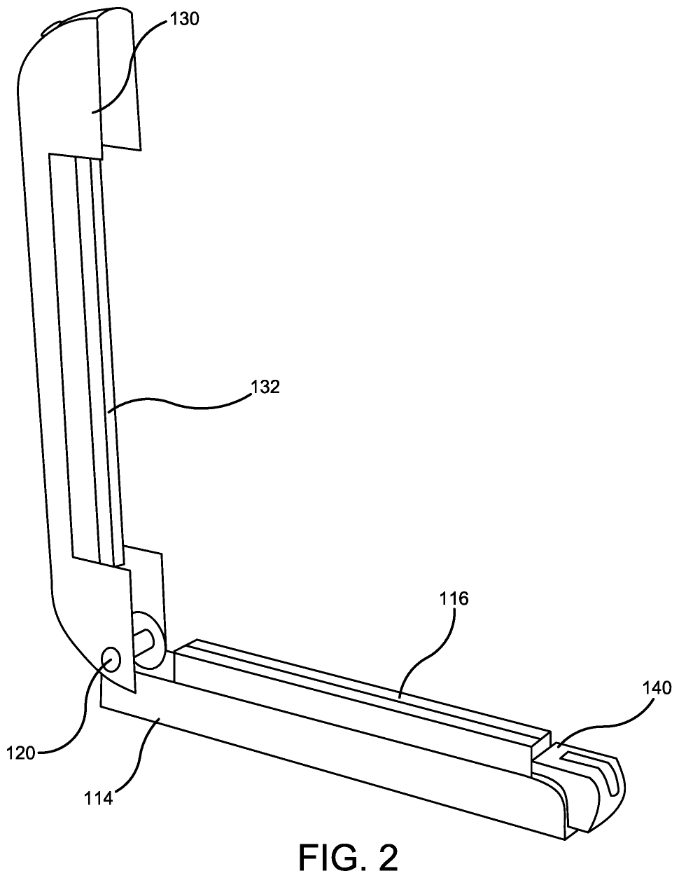

FIG. 2 illustrates a perspective view of one potential embodiment of a fishing rod holder device 100 of the present invention in an opened position in accordance with the disclosed architecture. The top member 130 of the device is further comprised of a top insert 132 and the base 110 is further comprised of a base insert 116. The top member 130 is connected to the base 110 via at least one hinge 120.

Further, the top insert 132 and the base insert 116 may be comprised of any soft material known in the art but is preferably a soft rubber that allows for the inserts 132, 116 to form to and around the shape of the fishing rods 10 when the device 100 is closed around the fishing rods 10. This allows for the fishing rods 10 to be securely held by the device 100 without damaging the fishing rods 10. The type of soft rubber that is used in the base insert 116 and the top insert 132 may be any rubber such as, but not limited to: EPDM rubber, thermoplastic elastomer, thermoplastic olefin, sponge rubber, natural rubbers, neoprene rubber elastomer, silicone rubber elastomer, ethylene propylene diene monomer rubber, butyl rubber, nitrile rubber, buna-n rubber, styrene-butadiene rubber elastomers, Viton rubber elastomer, diaphragm rubber, etc. In the preferred embodiment, the top insert 132 and the base insert 116 are comprised of a “V” shape to allow the fishing rods to be held safely in the device 100. In differing embodiments, the base insert 116 and the top insert 132 may be any shape that allows the fishing rods 10 to be safely secured in the device 100.

The device 100 is further comprised of at least one lock 140 that allows for the device 100 to close securely around the fishing rods 10 to keep the rods 10 secure while the user is driving the vehicle. There may be a plurality of lock 140 types that may be used such as, but not limited to: a padlock, a deadbolt lock, a cam lock, a rim/mortise lock, a euro profile cylinder lock, an interchangeable core cylinder lock, a furniture latch lock, a rim latch lock, a biometric fingerprint scanning lock, an RFID key fob lock, a mechanical dial lock, a numerical combination lock, a pedestal lock, a draw lock, a fixed core lock, etc.

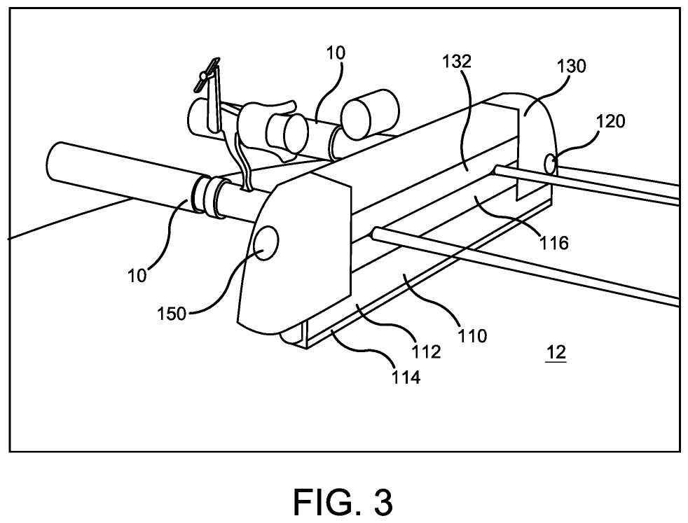

FIG. 3 illustrates a perspective view of one potential embodiment of a fishing rod holder device 100 of the present invention in a closed position while attached to a vehicle roof 12 and while retaining fishing rods 10 in accordance with the disclosed architecture. The base 110 of the device 100 is further comprised of a bottom surface 112 that further is comprised of at least one magnet 114 located on the bottom surface 112.

The magnets 114 can be any magnet 114 that is known in the art such as, but not limited to, neodymium iron boron, samarium cobalt, samarium cobalt, alnico, ferrite, electromagnet, etc. Further, the magnets 114 can be arranged in any orientation known in the art. The magnets 114 allow the device to be placed on any vehicle roof 12 without damaging the vehicle roof 12 or the device 100. The device 100 further has a release button 150 that disengages the locking mechanism 140. This allows for the user to easily open the top member 130 to retrieve the fishing rods 10 or place the fishing rods 10 in the device 100. The release button 150 may be any button/switch known to one skilled in the art.

In another embodiment, the device 100 may be comprised of at least one pouch 160. The pouch 160 provides a user with a place to store any other fishing supplies. The pouch 160 may be used to store a plurality of fishing supplies such as, but not limited to, hooks, lures, fillet knives, bobbers, etc. The pouch 160 may be made from a plurality of materials such as, but not limited to, netting, canvas, cloth, leather, etc. In another embodiment, the device 100 may be comprised of a spool 170 located on either the base 110 or the top member 130. The spool 170 is used to house fishing line so that the fishing line does not get tangled together in a tackle box or the pouch 160. The spool 170 may be any spool-like mechanism known to one skilled in the art.

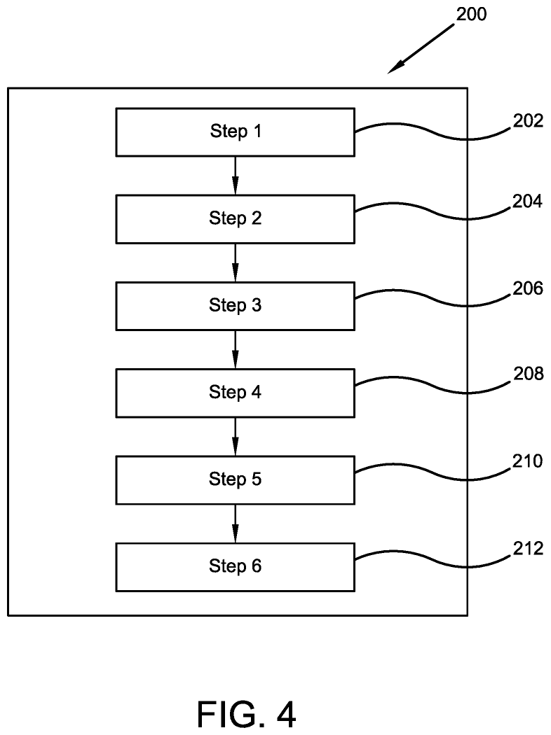

FIG. 4 illustrates a flowchart of one potential method 200 of using one potential embodiment of the fishing rod holder device of the present invention in accordance with the disclosed architecture. First, the user places one device 100 toward the back of the vehicle roof 12 [Step 202]. Next, the user places another device 100 toward the front of the vehicle roof 12 roughly the distance of the fishing rod 12 from the previously placed device 100 [Step 204]. Then, the user presses the release button 150 to open the top member 130 [Step 206]. The user then places the back of the fishing rod 10 on the base insert 116 of one of the devices 100 and places the front of the fishing rod 10 on the base insert 116 of the other device 100 [Step 208]. The user then closes the top members 130, which makes the top insert 132 hold the fishing rod snug in the devices 100 [Step 210]. The user then closes the top member 130 completely which engages the lock 140 [Step 212].

Then, the user will drive to their respective location [Step 214]. The user then pushes the release button 150 on both devices 100 to unlock the locks 150 [Step 216]. The user then opens the top members 130 of both devices 100 and retrieves the fishing rod 10 [Step 218]. Next, the user closes the top members 130 until the locking mechanisms 150 engage [Step 220]. Finally, when the user is done using the devices 100, the user can pick up on the devices 100 to pull the magnet 114, located on the bottom surface 112, off of the vehicle roof 12. The user can then store the device for future use [Step 222].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “fishing rod holder device” and “device” are interchangeable and refer to the fishing rod holder device 100 of the present invention.

Notwithstanding the foregoing, the fishing rod holder device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the fishing rod holder device 100 as shown in the FIGS. Are for illustrative purposes only, and that many other sizes and shapes of the fishing rod holder device 100 are well within the scope of the present disclosure. Although the dimensions of the fishing rod holder device 100 are important design parameters for user convenience, the fishing rod holder device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Ehat is claimed is:

1. A fishing rod holder device comprising:
a base comprised of a bottom surface and a base insert;
a hinge;
a top member comprised of a top insert; and
a lock.

2. The fishing rod holder device of claim 1, wherein the base is further comprised of a magnet.

3. The fishing rod holder device of claim 1, wherein the base is attached to the top member via the hinge.

4. The fishing rod holder device of claim 3, wherein the lock locks the base to the top member.

5. A fishing rod holder device comprising:
a base comprised of a bottom surface, a magnet and a base insert;
a hinge;
a top member comprised of a top insert;
a lock; and
a release button.

6. The fishing rod holder device of claim 5, wherein the release button disengages the lock.

7. The fishing rod holder device of claim 5, wherein the base insert is comprised of a soft rubber material.

8. The fishing rod holder device of claim 7, wherein the base insert is V-shaped.

9. The fishing rod holder device of claim 5, wherein the top insert is comprised of a soft rubber material.

10. The fishing rod holder device of claim 9, wherein the base insert is V-shaped.

11. The fishing rod holder device of claim 5 further comprised of a pouch.

12. The fishing rod holder device of claim 5 further comprised of a spool.

13. The fishing rod holder device of claim 5 further comprised of a hook.

14. The fishing rod holder device of claim 5 further comprised of a strap.

15. The fishing rod holder device of claim 14, wherein the strap is comprised of a fastener.

16. The fishing rod holder device of claim 15, wherein the fastener is a hook and loop fastener, a snap button fastener or a buckle fastener.

17. The fishing rod holder device of claim 5, wherein the hinge is an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge or a locking hinge.

18. The fishing rod holder device of claim 5, wherein the top member is comprised of a handle.

19. A method of using a fishing rod holder device, the method comprising the steps of:
placing a first fishing rod holder device on a vehicle roof;
placing a second fishing rod holder device on the vehicle roof apart from the first fishing rod holder device;
pressing a release button of the first fishing rod holder;
placing a portion of a fishing rod in the first fishing rod holder;
closing a top member of the first fishing rod holder around the fishing rod;
pressing a release button of the second fishing rod holder;
placing a portion of the fishing rod in the second fishing rod holder;
closing a top member of the second fishing rod holder around the fishing rod;
pressing the release button of the first fishing rod holder;
pressing the release button of the second fishing rod holder;
removing the fishing rod from the first fishing rod holder and from the second fishing rod holder; and
removing the first fishing rod holder and the second fishing rod holder from the vehicle roof

20. The fishing rod holder device of claim 19, wherein the fishing rod holder device is comprised of a handle.
